(19) United States
(12) Patent Application Publication
(10) Pub. No.: US 2011/0121142 A1
(43) Pub. Date: May 26, 2011

(54) ITEM HANGING HARDWARE

(75) Inventors: Liette Tousignant, Calgary (CA); Kelly Russell Krake, Calgary (CA); Kevin Charles Seel, Calgary (CA); Michael Kurtz, Calgary (CA); Nicole Kirsten Jannesson, Calgary (CA)

(73) Assignee: UNDER THE ROOF DECORATING INC., Calgary, AB (CA)

(21) Appl. No.: 13/003,695

(22) PCT Filed: Jun. 24, 2009
(86) PCT No.: PCT/CA2009/000880

§ 371 Date: Jan. 11, 2011

(30) Foreign Application Priority Data
Jul. 16, 2008 (CA) 2,637,964

(51) Int. Cl. F16B 15/02; F16M 13/02; F16L 3/08

(52) U.S. Cl. 248/73; 248/216.1

(57) ABSTRACT

A wall hardware device, a wire guide device, and an item hanging system including one or both of the wall hardware device and the wire guide device. The wall hardware device includes a straight nail and an auxiliary head. The auxiliary head includes a skirt section, a cap section and a throat section extending between the skirt section and the cap section. The nail extends through the skirt section and the throat section and terminates in the cap section. The wire guide device guides an item hardware wire into engagement with a wall hardware device. The wire guide device includes a connecting segment for connecting with the wall hardware device and a guiding segment for guiding the item hardware wire into engagement with the wall hardware device.

### TECHNICAL FIELD

Item hanging hardware for use in hanging an item such as a picture on an application surface such as a wall.

### BACKGROUND OF THE INVENTION

Items such as pictures and plaques are often displayed by hanging them from an application surface such as a wall. In order to hang an item from a wall, appropriate complementary item hanging hardware must be associated with the item and the wall. This complementary item hanging hardware may include item hardware and wall hardware. This complementary item hanging hardware may also include tools and/or aids for using item hardware and wall hardware, such as for example a guide device for guiding item hardware into engagement with wall hardware.

The item hardware is associated with the item and the wall hardware is associated with the wall. The item hardware may be comprised of one or more item hardware devices. The wall hardware may be comprised of one or more wall hardware devices.

As non-limiting examples, suitable item hardware devices may include a wire, a hook, a hanger, or a rail.

As a non-limiting example, a suitable wall hardware device may include a nail which is driven into the wall. The nail may engage with an item hardware device directly, or the wall hardware device may be further comprised of a hook, a hanger, rail or other suitable device associated with the nail which provide an engagement surface for engaging with the item hardware device.

Examples of the art relating to wall hardware devices include U.S. Pat. No. 169,739 (Stockton), U.S. Pat. No. 240,023 (Hofstatter), U.S. Pat. No. 406,255 (Brinkerhoff), U.S. Pat. No. 1,149,141 (Hook), U.S. Pat. No. 3,386,328 (Litfin), U.S. Pat. No. 3,482,812 (Leiser), U.S. Pat. No. 3,911,516 (Einhorn), U.S. Pat. No. 4,860,937 (Arnold), U.S. Pat. No. 4,897,007 (Chen et al), and U.S. Pat. No. 5,112,022 (Cardas).

Two-headed nails which are intended to facilitate the use of a claw hammer to remove the nail once it has been driven are known. Examples of the art relating to such two-headed nails include France Patent No. 601,536 (Sarton), U.S. Pat. No. 451,213 (Shepley), U.S. Pat. No. 975,310 (Ybarrondo), U.S. Pat. No. 1,160,191 (Neider), U.S. Pat. No. 1,242,924 (Collings), U.S. Pat. No. 1,276,764 (Holbrook), U.S. Pat. No. 1,407,641 (Cross), U.S. Pat. No. 1,705,371 (Mehlman), U.S. Pat. No. 5,755,545 (Banks), PCT International Publication No. WO 81/02916 (Morishima), and the aforementioned U.S. Pat. No. 240,023 (Hofstatter).

Two-headed nails which are intended to provide an anchoring mechanism for construction materials such as wire lathing, mortar and stucco are known. Examples of the art relating to such two-headed nails include U.S. Pat. No. 383,951 (Hegbom), U.S. Pat. No. 1,561,518 (Graham), U.S. Pat. No. 2,114,451 (Mattes), U.S. Pat. No. 5,024,038 (DePellegrini et al), U.S. Pat. No. 6,668,501 (Adebar et al), and U.S. Pat. No. 6,928,778 (Schmid).

There remains a need for a wall hardware device which is easy to attach to a wall, which provides a sturdy engagement surface for an item hardware device, and which is configured to assist in the engagement of the item hardware device with the wall hardware device. There also remains a need for a guide device for guiding an item hardware device into engagement with a wall hardware device. There also remains a need for item hanging systems which include such a wall hardware device and/or such a guide device.

### SUMMARY OF THE INVENTION

References in this document to dimensions, to orientations, to operating parameters, to ranges, to lower limits of ranges, and to upper limits of ranges are not intended to provide strict boundaries for the scope of the invention, but should be construed to mean “approximately” or “about” or “substantially”, within the scope of the teachings of this document, unless expressly stated otherwise.

The present invention is directed at a wall hardware device (referred to herein as a wall hardware device) for use in conjunction with wall hanging hardware (referred to herein as item hardware or as an item hardware device) for hanging an item on an application surface. The application surface may be a wall or a similar vertical surface. The item may be a picture, a plaque, or any other object which may be hung from the application surface.

The present invention is also directed at a guide device for guiding item hardware into engagement with a wall hardware device. In some embodiments, the guide device may be comprised of a wire guide device for guiding an item hardware wire into engagement with a wall hardware device.

The present invention is also directed at an item hanging system. The item hanging system may be comprised of a wall hardware device and/or a guide device.

In one exemplary aspect, the invention is a wall hardware device comprising:
(a) a straight nail having a longitudinal axis and comprising a point end, a head end, and a shank extending along the longitudinal axis between the point end and the head end; and
(b) an auxiliary head surrounding the head end of the nail and an embedded length of the shank of the nail adjacent to the head end, the auxiliary head comprising a skirt section, a cap section, and a throat section extending between the skirt section and the cap section, wherein the nail extends through the skirt section and the throat section and terminates in the cap section so that the head end of the nail is located within the cap section of the auxiliary head.

In another exemplary aspect, the invention is a wire guide device for guiding an item hardware wire into engagement with a wall hardware device, the wire guide device comprising a connecting segment for connecting with the wall hardware device and a guiding segment for guiding the item hardware wire into engagement with the wall hardware device, wherein the connecting segment and the guiding segment are connected with each other so that the connecting segment defines a first plane, the guiding segment defines a second plane, and a connecting angle separates the first plane from the second plane, and wherein the wire guide device is configured so that when the wall hardware device is attached to a wall and the connecting segment is engaged with the wall hardware device, the guiding segment extends upward and away from the wall.

In another exemplary aspect, the invention is an item hanging system comprising a wall hardware device, the wall hardware device comprising:
(a) a straight nail having a longitudinal axis and comprising a point end, a head end, and a shank extending along the longitudinal axis between the point end and the head end; and
(b) an auxiliary head surrounding the head end of the nail and an embedded length of the shank of the nail adjacent to the head end, the auxiliary head comprising a skirt section, a cap section, and a throat section extending between the skirt section and the cap section, wherein the nail extends through the skirt section and the throat section and terminates in the cap section so that the head end of the nail is located within the cap section of the auxiliary head.

In some embodiments according to this exemplary aspect, the item hanging system may further comprise a wire guide device for connecting with the wall hardware device in order to guide an item hardware wire into engagement with the auxiliary head. In some embodiments, the wire guide device may be comprised of a connecting segment for connecting with the wall hardware device and a guiding segment for guiding the item hardware wire into engagement with the auxiliary head.

In another exemplary aspect, the invention is an item hanging system comprising a wire guide device for guiding an item hardware wire into engagement with a wall hardware device, the wire guide device comprising a connecting segment for connecting with the wall hardware device and a guiding segment for guiding the item hardware wire into engagement with the wall hardware device, wherein the connecting segment and the guiding segment are connected with each other so that the connecting segment defines a first plane, the guiding segment defines a second plane, and a connecting angle separates the first plane from the second plane, and wherein the wire guide device is configured so that when the wall hardware device is attached to a wall and the connecting segment is engaged with the wall hardware device, the guiding segment extends upward and away from the wall.

In another exemplary aspect, the invention is an item hanging system comprising a wall hardware device and a wire guide device for guiding an item hardware wire into engagement with a wall hardware device, the wire guide device comprising a connecting segment for connecting with the wall hardware device and a guiding segment for guiding the item hardware wire into engagement with the wall hardware device, wherein the connecting segment and the guiding segment are connected with each other so that the connecting segment defines a first plane, the guiding segment defines a second plane, and a connecting angle separates the first plane from the second plane, and wherein the wire guide device is configured so that when the wall hardware device is attached to a wall and the connecting segment is engaged with the wall hardware device, the guiding segment extends upward and away from the wall.

In some applications of the invention, the application surface may be a wall. In some applications of the invention, the item may be a picture or a plaque. However, the principles of the invention are applicable for use in association with a wide range of different application surfaces and items. As a result, reference in this document to “wall” or to “picture” is intended to include other application surfaces and items respectively, unless expressly stated otherwise.

The nail of the wall hardware device may be constructed of any material or combination of materials which are suitable for use in association with the application surface. In some embodiments, the nail may be constructed of a metal.

The shank of the nail may be smooth or textured. In some embodiments, the shank of the nail may be comprised of a smooth segment adjacent to the head end of the nail and a textured segment adjacent to the point end of the nail. In some embodiments, the smooth segment of the shank is comprised of the embedded length of the shank.

The auxiliary head of the wall hardware device may be constructed of any material or combination of materials which are suitable for use in association with the nail and the application surface. In some embodiments, the auxiliary head may be constructed of a plastic.

The auxiliary head may be connected with the nail in any suitable manner. In some embodiments, the auxiliary head may be molded onto the nail. In some embodiments, the auxiliary head may be injection molded onto the nail.

The skirt section of the auxiliary head may be comprised of a base. The base may be comprised of a planar bearing surface facing the point end of the nail. The bearing surface may be perpendicular to the longitudinal axis of the nail.

The base of the skirt has a cross-sectional area and the throat section of the auxiliary head has a cross-sectional area. In some embodiments, the cross-sectional area of the base may be greater than the cross-sectional area of the throat section.

In some embodiments, the skirt section of the auxiliary head may be tapered between the base of the skirt section and the throat section of the auxiliary head in order to provide an oblique skirt shoulder on the skirt section. The oblique skirt shoulder faces the throat section.

In some embodiments, the cap section of the auxiliary head may be comprised of a top end. In such embodiments, the top end of the cap section has a cross-sectional area. In some embodiments, the cross-sectional area of the top end may be greater than the cross-sectional area of the throat section.

In some embodiments, the cap section of the auxiliary head may be tapered between the top end of the cap section and the throat section of the auxiliary head in order to provide an oblique cap shoulder on the cap section. The oblique cap shoulder faces the throat section.

In some embodiments, the auxiliary head may be further comprised of a fillet between the cap section and the throat section. In some embodiments, the auxiliary head may be further comprised of a fillet between the oblique cap shoulder and the throat section.

In some embodiments, the cross-sectional area of the top end of the cap section may be less than the cross-sectional area of the base of the skirt section.

The wire guide device may be configured to be used in conjunction with a wall hardware device according to the invention or with other types of wall hardware devices. As a non-limiting example, the wire guide device may be configured to be used with a typical nail as the wall hardware device.

In some embodiments, the connecting segment of the wire guide device may be comprised of a connecting notch for engaging with a wall hardware device. In some embodiments in which the wire guide device is configured to be used with a wall hardware device according to the invention, the connecting segment of the wire guide device may be comprised of a connecting notch for engaging with the throat section of the auxiliary head of the wall hardware device.

In some embodiments, the connecting segment of the wire guide device may have a proximal end and a distal end and the connecting notch may be located between the proximal end and the distal end of the connecting segment. In some embodiments, the connecting segment may be constructed of a resilient material (i.e., a material which can readily be deformed or deflected elastically). In some embodiments, the connecting segment may be further comprised of a concave connecting bow profile between the proximal end and the distal end of the connecting segment so that when the wall hardware device is attached to a wall and the connecting segment is engaged with the wall hardware device, the proximal end and the distal end of the connecting segment are urged into engagement with the wall.

In some embodiments, the guiding segment of the wire guide device may have a proximal end and a distal end. In some embodiments, the guiding segment may be constructed of a resilient material (i.e., a material which can readily be deformed or deflected elastically). In some embodiments, the guiding segment may be comprised of a concave guiding bow profile between the proximal end and the distal end of the guiding segment.

In some embodiments, the wire guide device may be constructed as a single piece of a resilient material. In some embodiments, the wire guide device may be constructed of a single piece of a plastic.

Embodiments of the wall hardware device may provide one or more advantages in comparison with known wall hardware devices, including but not limited to: (i) a high strength to cost ratio; (ii) flexibility in auxiliary head design; (iii) flexibility in nail head diameter to shank ratio; (iv) economization of mass production capability; (v) reduced damage to the application surface; (vi) secure and safe engagement of item hardware with the wall hardware device; (vii) protection of fingers during use; and (viii) prevention of being driven too far into the application surface.

### BRIEF DESCRIPTION OF DRAWINGS

Embodiments of the invention will now be described with reference to the accompanying drawings, in which:

FIG. 1 is a cross-sectional view of an embodiment of a wall hardware device according to the invention.

FIG. 2 is a side view of the wall hardware device of FIG. 1.

FIG. 3 is an end view of the auxiliary head of the wall hardware device of FIG. 1.

FIG. 4(a) and FIG. 4(b) are a side view and an end view of the auxiliary head respectively for an alternate embodiment of a wall hardware device according to the invention.

FIG. 5(a) and FIG. 5(b) are a side view and an end view of the auxiliary head respectively for an alternate embodiment of a wall hardware device according to the invention.

FIG. 6(a) and FIG. 6(b) are a side view and an end view of the auxiliary head respectively for an alternate embodiment of a wall hardware device according to the invention.

FIG. 7(a) and FIG. 7(b) are a side view and an end view of the auxiliary head respectively for an alternate embodiment of a wall hardware device according to the invention.

FIG. 8(a) and FIG. 8(b) are a side view and an end view of the auxiliary head respectively for an alternate embodiment of a wall hardware device according to the invention.

FIG. 9(a) and FIG. 9(b) are a side view and an end view of the auxiliary head respectively for an alternate embodiment of a wall hardware device according to the invention.

FIG. 10(a) and FIG. 10(b) are a side view and an end view of the auxiliary head respectively for an alternate embodiment of a wall hardware device according to the invention.

FIG. 11 is a pictorial view depicting securing the wall hardware device to the wall at a 90 degree angle.

FIG. 12(a) and FIG. 12(b) are pictorial views illustrating the finger protection during attachment of the wall hardware device and a typical nail respectively to an application surface.

FIG. 13(a) and FIG. 13(b) are a side view and a plan view respectively of an embodiment of a wire guide device according to the invention.

FIG. 14 is a pictorial view of two of the wire guide devices of FIG. 13, depicting the connecting segments engaged with respective wall hardware devices.

FIG. 15 is a pictorial view of two of the wire guide devices of FIG. 13, depicting the guiding of an item hardware wire into engagement with the wall hardware devices.

### DETAILED DESCRIPTION

In the description which follows, references to dimensions of features and components of the invention represent non-limiting examples.

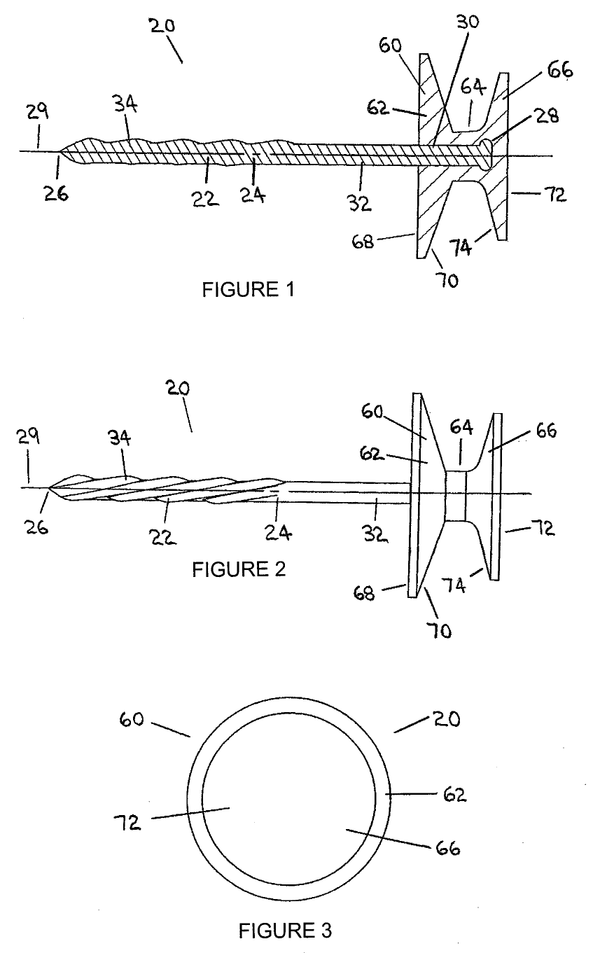

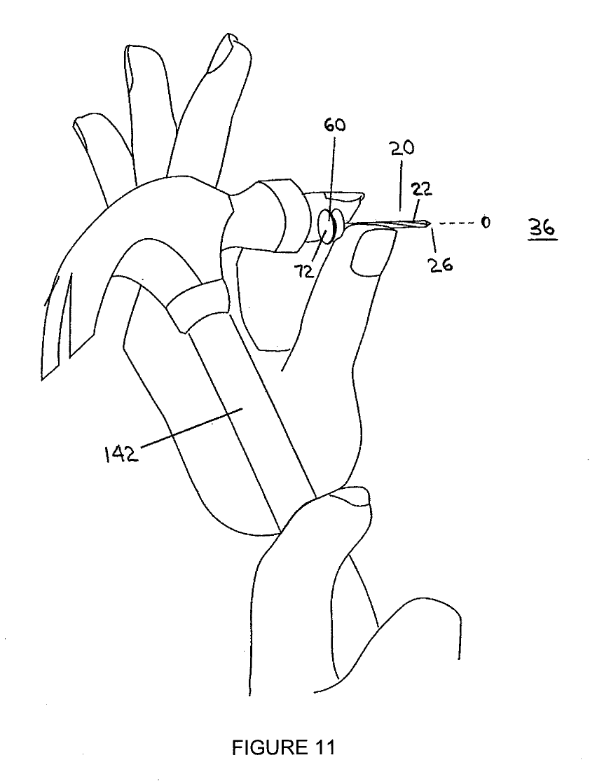

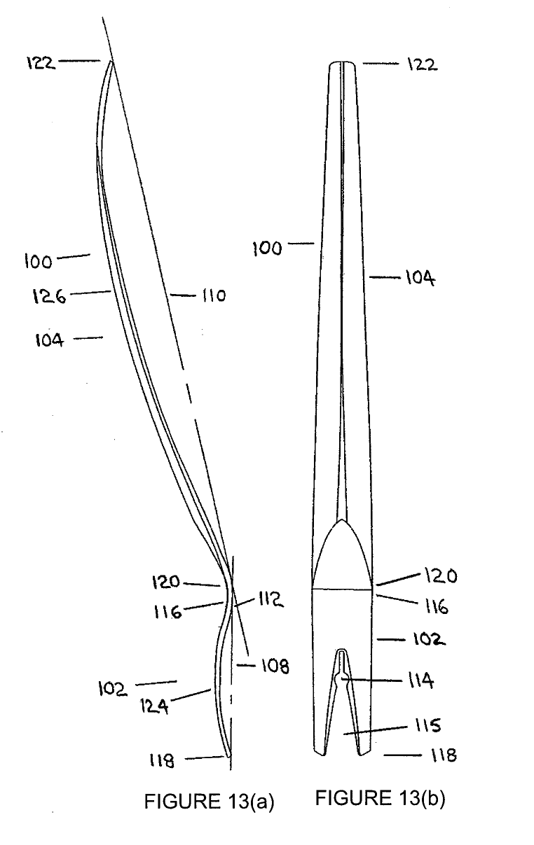

Referring to FIGS. 1-12, embodiments of a wall hardware device (20) are depicted. Referring to FIGS. 13-15, an embodiment of a wire guide device (100) is depicted. The wall hardware device (20) and the wire guide device (100) represent possible components of an item hanging system (140) which may be comprised of the wall hardware device (20) and/or the wire guide device (100).

Referring to FIG. 1, FIG. 2, and FIG. 11, the wall hardware device (20) is comprised of a straight nail (22) including a shank (24), a point end (26) and a head end (28). The nail (22) has a longitudinal axis (29). The wall hardware device (20) is also comprised of an auxiliary head (60) having specific features as described herein.

The nail (22) may be constructed of any suitable material. In the embodiments depicted in the Figures, the nail (22) is constructed of steel. The auxiliary head (60) may be constructed of any suitable material. As depicted in the Figures, the auxiliary head (60) is constructed of a plastic.

The auxiliary head (60) and the nail (22) may be joined by any suitable means or process. For example, the auxiliary head (60) and the nail (22) may be joined through a one-step thermal injection molding process in which the auxiliary head (60) is injected into a mold onto the head end (28) of the nail (22). The auxiliary head (60) surrounds the head end (28) of the nail (22) as well as an embedded length (30) of the shank (24).

As depicted in the Figures, the shank (24) of the nail (22) is comprised of two different segments. The portion of the shank (24) adjacent to the head end (28) is a smooth segment (32) having a constant diameter cross-section while the extension of the shank (24) from the end of the smooth segment (32) to the point end (26) of the nail (22) is a textured segment (34) having rings, spirals or other discontinuities. The nominal diameter of the nail (22) is preferably optimized to provide maximum strength while minimizing the size of the hole caused by the nail (22) in an application surface (36).

The smooth segment (32) of the shank (24) of the nail (22) adjacent to the auxiliary head (60) provides for a consistent surface for the auxiliary head (60) to adhere to and therefore allows for optimum joining of the nail (22) and the auxiliary head (60) during the production process, particularly where the auxiliary head (60) is constructed of a plastic. The smooth segment (32) of the shank (24) permits consistent cooling of the plastic following the injection molding process. This, in turn, allows maximum strength of the wall hardware device (20) and minimizes surface irregularities in the finished wall hardware device (20). As a result, the smooth segment (32) is preferably comprised of or includes the embedded length (30) of the shank (24).

The smooth segment (32) preferably extends beyond the auxiliary head (60). The length of the non-embedded portion of the smooth segment (32) is preferably selected so that there is adequate space to provide consistent joining of the nail (22) and the auxiliary head (60) but not so long as to sacrifice length for the textured segment (34) of the shank (24). In the embodiments depicted in the Figures, the length of the non-embedded portion of the smooth segment (32) of the shank (24) is about 6 mm.

The textured segment (34) of the shank (24) of the nail (22) may provide a resistive function to aid in axially securing the wall hardware device to the application surface (36). As depicted in the Figures, the textured segment (34) of the shank (24) is comprised of helically shaped spirals. The resistance created by the helically shaped textured segment (34) may increase the amount of force required to pull the wall hardware device (20) from the application surface (36) by as much as 50-100 times, depending on the construction of the application surface (36). As a result, the wall hardware device (20) may remain more stable over time and may be able to carry a greater overall load. The length of the textured segment (34) of the shank (24) is preferably selected to maximize the amount of textured segment (34) of the shank (24) which is in contact with any wallboard of standard thickness when the wall hardware device (20) is applied to an application surface (36) comprising wallboard. As depicted in the Figures, the length of the textured segment (34) of the shank (24) is about 18 mm.

The nail (22) may have an enlarged head (40) at the head end (28) of the nail (22). The head (40) of the nail (22), which becomes embedded within the auxiliary head (60) during the production of the wall hardware device (20), serves to provide axial and perpendicular support to the auxiliary head (60) following the joining process. The auxiliary head (60) is preferably formed so that a sufficient amount of material surrounds the nail (22) at any radial position to ensure structural stability and rigidity of the auxiliary head (60) during use of the wall hardware device (20). As depicted in the Figures, about 0.5 mm of plastic material surrounds the head (40) of the nail (22) at any radial position.

In addition, the head (40) of the nail (22) is preferably embedded into the auxiliary head (60) a sufficient longitudinal distance so that the nail (22) remains the prime vertical load bearing component of the wall hardware device (22).

The auxiliary head (60) is also preferably joined perpendicular to the shank (24) of the nail (22) in order to provide greater accuracy to the desired location when securing the nail (22) into the application surface (36) at a 90 degree angle, as depicted in FIG. 11. Where the auxiliary head (60) is constructed of a molded plastic, preferably a sufficient thickness of plastic material is provided between the head end (28) of the nail (22) and the top of the auxiliary head (60) to ensure successful and consistent forming of the auxiliary head (60). As depicted in the Figures, this thickness is about 1.5 mm. This thickness preferably provides for a consistent and solid edge to be formed during the molding process and minimizes the chance of distortion at the edges of the auxiliary head (60) due to uneven rates of material cooling.

The auxiliary head (60) of the wall hardware device (20) is preferably constructed of a plastic material (instead of, for example, a metal) for several reasons.

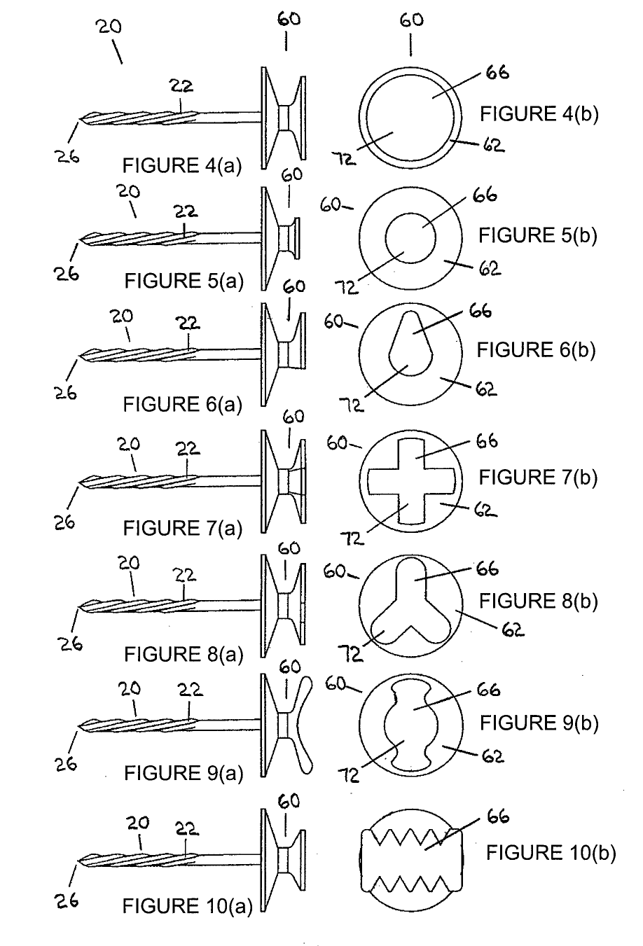

First, one of the objectives of the design for the wall hardware device (20) is to provide different configurations for the auxiliary head (60) in order to accommodate different types of item hardware. Such different configurations are easily facilitated by constructing the auxiliary head (60) of a plastic material, as depicted in FIGS. 4-10. The possible configurations of the auxiliary head (60) are not limited to those depicted in FIGS. 4-10, and could include a near endless number of possibilities for both functional and decorative purposes.

Second, the use of a plastic material for the auxiliary head (60) allows flexibility in the colour of the auxiliary head (60), since plastic can be produced in a wide range of colours.

Third, while it is possible to manufacture the wall hardware device (20) using techniques such as cold forming or machining, such techniques may not be as economically attractive for mass production based on cycle times, labour effort and material cost. In addition, the use of a cold forming process to manufacture the wall hardware device (20) would limit the ratio of the diameter of the nail (22) to the diameter of the auxiliary head (60) to 1:2.5, which would limit the flexibility of the design of the auxiliary head (60).

The shape of the wall hardware device (20) could also be achieved by combining two separately fabricated metal components (i.e., the nail (22) and the auxiliary head (60)) in a tertiary production step. However, this production method would likely be less efficient and more expensive than an injection molding process using a plastic material for the auxiliary head (60).

Suitable plastic materials for the auxiliary head (60) include those plastics which are typically used in impact applications, since the auxiliary head (60) must be capable of withstanding repeated strikes with a hammer without fracturing and without experiencing significant plastic deformation. Consequently, suitable plastic materials for the auxiliary head (60) preferably exhibit good impact resistance, as well as good stability and flexibility.

From testing procedures, it was determined that five strikes with a hammer was the average number of strikes required to drive a common nail into a wall constructed of ⅝″ gypsum wallboard. As a result, the plastic material which is chosen for the auxiliary head (60) is preferably able to withstand a minimum of five strikes from a 16 oz (455 g) hammer, which is a standard size of hammer found in a layperson's home.

Possible suitable plastic candidates include, but are not limited to various types of nylon, (such as Nylatron™ NSM or Nylatron™ GSM, produced by Quadrant Engineering Plastic Products, Inc.), polypropylene (such as SABIC™ PP 910MNK40, produced by Saudi Basic Industries Corporation (SABIC)), acrylonitrile butadiene styrene (ABS) (such as Cycolac™ or Cycoloy™, produced by Saudi Basic Industries Corporation (SABIC)), polypropylene, Tenite™ (produced by Eastman Chemical Company, and polycarbonate (such as SABIC™ OR GE PC 141, produced by Saudi Basic Industries Corporation (SABIC)).

One plastic material which may be suitable for some applications of the invention is nylon 6 because nylon 6 has specific properties which give it an advantage in the injection molding process over other plastic materials. Nylon 6 material provides a relatively high flexural modulus (ability to resist deflection or deformation by an applied force), a relatively high flexural strength (stress required to deform the material) and a relatively high impact resistance. These properties allow nylon 6 to be used in applications which require the product to withstand multiple impacts with a blunt object, such as a hammer, without deformation or failure. However, nylon 6 may not be suitable for use in relatively dry climates, since nylon 6 may become brittle if it is permitted to dehydrate.

Another plastic material which has been found to be suitable and preferable in relatively dry climates is polycarbonate (such as SABIC™ OR GE PC 141), which exhibits a suitably high impact resistance, stability and flexibility, and which is less susceptible to brittleness due to dehydration than is nylon 6.

The auxiliary head (60) of the wall hardware device (20) may be designed to specific dimensions in order to satisfy both functional requirements and manufacturing constraints.

As depicted in FIG. 1 and FIG. 2, the auxiliary head (60) is comprised of a skirt section (62), a throat section (64) and a cap section (66). Together, these three sections (62,64,66) of the auxiliary head (60) provide a secure position to accommodate many types of item hardware, while minimizing the distance the wall hardware device (20) protrudes from the application surface (36) in order to be aesthetically pleasing. While the throat section (64) provides the actual vertical load bearing surface upon which the item hardware is supported, the skirt section (62) bears the horizontal stresses acting between the wall hardware device (20) and the application surface (36) and the cap section (66) prevents the item hardware from slipping off the throat section (64).

The skirt section (62) of the auxiliary head (60) is comprised of a base (68). The cross-sectional area of the base (68) of the skirt section (62) is preferably selected to increase the surface area in contact with the application surface (36) as compared with a typical nail. As depicted in FIG. 1 and FIG. 2, the diameter of the base (68) is about 12 mm. By increasing the cross-sectional area of the portion of the skirt section (62) which is in contact with the application surface (36), the stress applied to the application surface (36) may be decreased and the ensuing stresses may be better distributed.

As a result, not only does the load carrying capacity of the wall hardware device (20) potentially increase, but less damage to the application surface (36) may possibly be incurred during installation and use of the wall hardware device (20). For example, a base (68) of the skirt section (62) having a diameter of 12 mm may provide a 16× increased surface area in comparison with a typical nail, while also providing an added benefit of protecting fingers while attaching the wall hardware device (20) to the application surface (36).

The thickness of the base (68) of the skirt section (62) is preferably minimized in order to keep the vertical load bearing throat section (64) as close to the application surface (36) as possible.

The cross-sectional area of the base (68) of the skirt section is greater than the cross-sectional area of the throat section (64). The skirt section (62) may be tapered between the base (68) and the throat section (64) in order to provide an oblique skirt shoulder (70) on the skirt section (62) facing the throat section (64). The oblique skirt shoulder (70) is angled in order to guide item hardware onto the throat section (64) of the auxiliary head (60). The minimized thickness of the base (68) of the skirt section (62) and the angle of the oblique skirt shoulder (70) are preferably configured to effectively guide any item hardware onto the throat section (64) without the item hardware becoming caught on the base (68) of the skirt section (62). As depicted in the Figures, the angle of the oblique skirt shoulder (70) is about 21 degrees.

Despite the above design considerations, a minimum thickness of the base (68) of the skirt section (62) may be desirable to ensure successful and consistent manufacturing of the auxiliary head (60). The minimum thickness preferably provides for a consistent and solid edge to be formed during the injection molding process and minimizes the chance of distortion at the edges of the auxiliary head (60) due to uneven rates of material cooling. As depicted in the Figures, the thickness of the base (68) of the skirt section (62) is about 0.5 mm.

The throat section (64) of the auxiliary head (60) is preferably configured to accommodate item hardware of various sizes. As depicted in the Figures, the nail (22) extends through the skirt section (62) and the throat section (64) and terminates in the cap section (66) so that the head end (28) of the nail (22) is located within the cap section (66) and so that the nail (22) and not the auxiliary head (60) is the primary vertical load bearing component of the wall hardware device (22).

As previously stated, the auxiliary head (60) is preferably formed so that a sufficient amount of material surrounds the nail (22) at any radial position to ensure structural stability and rigidity of the auxiliary head (60) during use. As depicted in the Figures, the diameter of the throat section (64) provides about 0.5 mm of plastic material surrounding the embedded length (30) of the shank (24) of the nail (22) which extends through the throat section (64).

The cap section (66) of the auxiliary head (60) is preferably configured to be able to withstand multiple hammer impacts during the installation of the wall hardware device (20) while providing a barrier necessary to keep the item hardware from slipping off the wall hardware device (20) during use of the wall hardware device (20).

Design measures are preferably taken to ensure that the cap section (66) and the throat section (64) of the auxiliary head (60) are strong enough to withstand the forces generated by hammer impacts during the installation of the wall hardware device (20).

First, the cap section (66) has a top end (72) and the cross-sectional area of the top end (72) of the cap section (66) is greater than the cross-sectional area of the throat section (64). In order to strengthen the cap section (66), the cap section (66) may be tapered between a top end (72) of the cap section (66) and the throat section (64) in order to provide an oblique cap shoulder (74) on the cap section (66) facing the throat section (64).

The oblique cap shoulder (74) is angled in order to direct item hardware back toward the skirt section (62) of the auxiliary head (60) so that the item being hanged is directed into close proximity with the application surface (36) upon which it is being hanged. The angle is selected to redirect impact stresses imposed by a hammer on the top end (72) of the cap section (66) toward the throat section (64) and thus toward the nail (22). As depicted in the Figures, the angle is about 10 degrees.

Second, to reduce the stress concentrations between the cap section (66) and the throat section (64) of the auxiliary head (60) caused by hammer impacts, the transition between the oblique cap shoulder (74) and the throat section may be provided with a fillet (72).

The combined effects of these two design measures may result in a decrease in the stress magnitude on the auxiliary head (60) by a factor of up to 5 compared to an auxiliary head (60) without these features. As with the base (68) of the skirt section (62), a minimum thickness of the cap section (66) may be desirable to enable a consistent and solid edge to be formed during the injection molding process. This, in turn, allows for consistent cooling of the plastic to avoid any surface irregularities during the manufacturing process. As depicted in the Figures, the thickness of the cap section (66) is about 0.5 mm.

The cross-sectional area of the top end (72) of the cap section (66) may be less than, equal to, or greater than the cross-sectional area of the base (68) of the skirt section (62). As depicted in the Figures, the cross-sectional area of the top end (72) of the cap section (66) is less than the cross-sectional area of the base (68) of the skirt section (62).

The cap section (66) and the throat section (64) are sized so that the cap section (66) is large enough relative to the throat section (64) to assist in preventing item hardware placed upon the throat section (62) of the auxiliary head (60) from slipping off the wall hardware device (20).

The wall hardware device (20) of the invention may be used in association with a wide range of different item hardware. The wall hardware device (20) of the invention may also be used in association with a guide device for guiding item hardware into engagement with the wall hardware device (20).

In some embodiments, the wall hardware device (20) may be used in association with item hardware which is comprised of an item hardware wire. In such embodiments, the wire guide device (100) may be used in association with the wall hardware device (20) in order to guide the item hardware wire into engagement with the wall hardware device (20).

Referring to FIGS. 13-15, an exemplary non-limiting embodiment of the wire guide device (100) is depicted.

The wire guide device (100) is comprised of a connecting segment (102) for connecting with the wall hardware device (20) and a guiding segment (104) for guiding the item hardware wire (106) into engagement with the auxiliary head (60) of the wall hardware device (20). The connecting segment (102) may be connected with the wall hardware device (20) in any suitable manner.

The connecting segment (102) and the guiding segment (104) are connected with each other so that the connecting segment (102) defines a first plane (108), the guiding segment defines a second plane (110), and a connecting angle (112) separates the first plane (108) from the second plane (110).

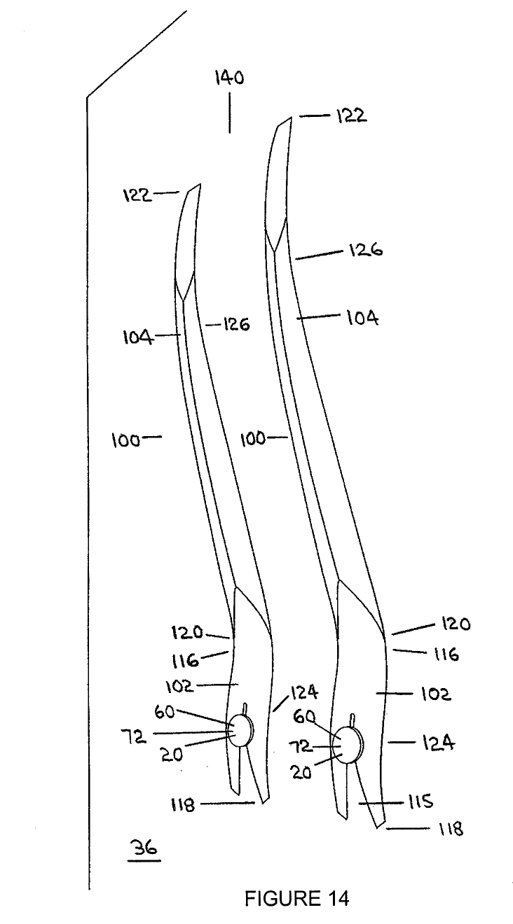

The wire guide device (100) is configured so that when the wall hardware device (20) is attached to the application surface (36) and the connecting segment (102) is engaged with the wall hardware device (20), the guiding segment (104) extends upward and away from the application surface (36). As depicted in FIGS. 13-14, the wire guide device (100) is also configured so that when the connecting segment (102) is engaged with the wall hardware device (20), the first plane is substantially parallel with the application surface (36).

The connecting segment (102) is comprised of a connecting notch (114) for engaging with the wall hardware device (20). More particularly, as depicted in FIGS. 13-14, the connecting notch (114) is configured to engage with the throat section (64) of the wall hardware device (20).

The connecting segment (102) has a proximal end (116) and a distal end (118). The guiding segment (104) also has a proximal end (120) and a distal end (122). The connecting segment (102) and the guiding segment (104) are connected at their respective proximal ends (116,120).

As depicted in FIGS. 13-15, the connecting notch (114) is a portion of a connecting slot (115). The connecting slot (115) extends from the distal end (118) of the connecting segment (102) toward the proximal end (116) of the connecting segment (102), and the connecting notch (114) is located between the proximal end (116) and the distal end (118) of the connecting segment (102).

As depicted in FIGS. 13-15, the connecting segment (102) is constructed of a resilient material and the connecting segment (102) is comprised of a concave connecting bow profile (124) between the ends (116,118) of the connecting segment (102), so that the first plane (108) may be considered as a straight line between the ends (116,118) of the connecting segment (102).

As a result of the connecting bow profile (124), when the wall hardware device (20) is attached to the application surface (36) and the connecting segment (102) is engaged with the wall hardware device (20), the proximal end (116) and the distal end (118) are urged into engagement with the application surface (36), thereby securing the wire guide device (100) to the application surface (36).

As depicted in FIGS. 13-15, the guiding segment (104) is constructed of a resilient material and the guiding segment (104) is comprised of a concave guiding bow profile (126) between the ends (120,122) of the guiding segment (104), so that the second plane (110) may be considered as a straight line between the ends (120,122) of the guiding segment (104).

As a result of the guiding bow profile (126), when the wall hardware device (20) is attached to the application surface (36) and the connecting segment (102) is engaged with the wall hardware device (20), the distal end (122) of the guiding segment (104) curves back toward the application surface (36) in order to assist in “trapping” the item hardware wire (106) between the application surface (36) and the guiding segment (104).

As depicted in FIGS. 13-15, the concave guiding bow profile (126) has a greater curvature near the distal end (122) of the guiding segment (104) than near the proximal end (120) of the guiding segment (104). This configuration facilitates greater clearance between the application surface (36) and the guiding segment (104) than if the curvature near the proximal end (120) of the guiding segment (104) was increased, and also reduces the likelihood of the item hardware wire (106) slipping out from between the application surface (36) and the guiding segment (104) adjacent the distal end (122) of the guiding segment (104).

As depicted in FIGS. 13-15, the wire guide device (100) is constructed as a single piece of a resilient material. More particularly, as depicted in FIGS. 13-15, the wire guide device (100) is constructed of a single piece of a plastic.

The wall hardware device (20) and the wire guide device (100) may be used as components of an item hanging system (140). Referring to FIGS. 11-12 and 14-15, the depicted item hanging system (140) includes two wall hardware devices (20) and two wire guide devices (100). However, the item hanging system (140) may include any number of wall hardware devices (20) and wire guide devices (100).

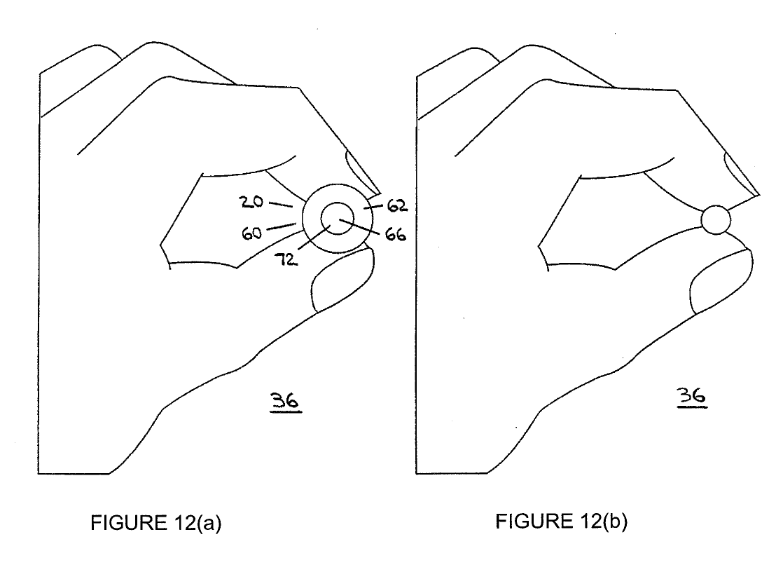

First, referring to FIGS. 11-12, each of the wall hardware devices (20) is attached to the application surface (36), such as a wall, by using a hammer (142) to drive the wall hardware devices (20) into the application surface (36). The hammer (142) strikes the top end (72) of the cap section (66) of the auxiliary head (60) while fingers are protected behind the cap section (66). The wall hardware devices (20) are driven into the application surface (36) at a 90 degree angle so that the longitudinal axes (29) of the nails (22) are perpendicular to the application surface (36).

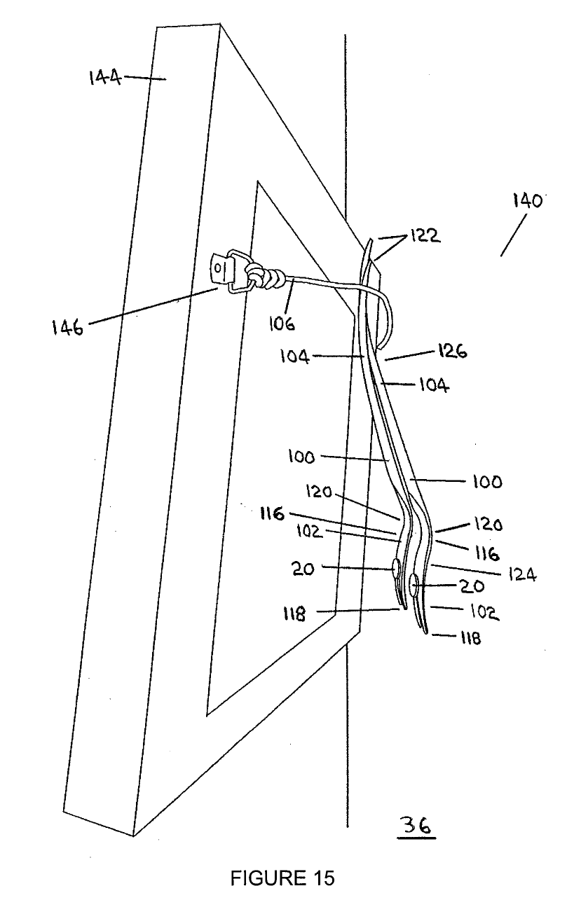

Second, referring to FIGS. 14-15, the wire guide devices (100) are engaged with the wall hardware devices (20) by sliding the throat sections (66) of the auxiliary heads (60) of the wall hardware devices (20) through the connecting slots (115) of the connecting segments (102) until the connecting notches (114) engage with the throat sections (66) on the wall hardware devices (20). The connecting segments (102) of the wire guide devices (100) will be elastically deformed as the throat sections (66) pass through the connecting slots (115), thereby causing the proximal ends (116) and the distal ends (118) of the connecting segments (102) to be urged into engagement with the application surface (36).

Third, also referring to FIGS. 14-15, an item (144) is hung on the application surface (36) by engaging item hardware (146) with the wall hardware devices (20). The item hardware (146) is associated with the item (144) and is complementary to and compatible with the wall hardware devices (20).

As depicted in FIGS. 14-15, the item hardware (146) includes the item hardware wire (106), which extends between edges of the item (144). As a result, engaging the item hardware (146) with the wall hardware devices (20) is comprised of engaging the item hardware wire (106) with the wall hardware devices (20).

This engagement is achieved by passing the item hardware wire (106) between the distal end (122) of the guiding segment (104) of each of the wire guide devices (100) and the application surface (36) and then moving the item (144) downward so that the guiding segments (104) guide the item hardware wire (106) into engagement with the throat sections (64) of the wall hardware devices (20). The guiding segments (104) will be elastically deformed between the item (144) and the application surface (36) as the item (144) moves closer to the application surface (36).

Once the item hardware wire (106) is in engagement with the throat sections (64) of the wall hardware devices (20), the item (144) will be supported by the wall hardware devices (20). The wire guide devices (100) may then either remain engaged with the wall hardware devices (20), or may be removed and reused.

In this document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The embodiments of the invention in which an exclusive property or privilege is claimed are defined as follows:

1. An item hanging system comprising a wall hardware device, the wall hardware device comprising:
(a) a straight nail having a longitudinal axis and comprising a point end, a head end, and a shank extending along the longitudinal axis between the point end and the head end; and
(b) an auxiliary head surrounding the head end of the nail and an embedded length of the shank of the nail adjacent to the head end, the auxiliary head comprising a skirt section, a cap section, and a throat section extending between the skirt section and the cap section, wherein the nail extends through the skirt section and the throat section and terminates in the cap section so that the head end of the nail is located within the cap section of the auxiliary head.

2. The item hanging system as claimed in claim 1 wherein the nail is constructed of a metal and wherein the auxiliary head is constructed of a plastic.

3. The item hanging system as claimed in claim 2 wherein the auxiliary head is molded onto the nail.

4. The item hanging system as claimed in claim 2 wherein the auxiliary head is injection molded onto the nail.

5. The item hanging system as claimed in claim 2 wherein the skirt section of the auxiliary head is comprised of a base, wherein the base is comprised of a planar bearing surface facing the point end of the nail, and wherein the bearing surface is perpendicular to the longitudinal axis of the nail.

6. The item hanging system as claimed in claim 5 wherein the base of the skirt section has a cross-sectional area, wherein the throat section of the auxiliary head has a cross-sectional area, and wherein the cross-sectional area of the base is greater than the cross-sectional area of the throat section.

7. The item hanging system as claimed in claim 6 wherein the skirt section of the auxiliary head is tapered from the base of the skirt section to the throat section of the auxiliary head in order to provide an oblique skirt shoulder on the skirt section and wherein the oblique skirt shoulder faces the throat section.

8. The item hanging system as claimed in claim 7 wherein the cap section of the auxiliary head is comprised of a top end, wherein the top end of the cap section has a cross-sectional area, wherein the cross-sectional area of the top end is greater than the cross-sectional area of the throat section.

9. The item hanging system as claimed in claim 8 wherein the cap section of the auxiliary head is tapered from the top end of the cap section to the throat section of the auxiliary head in order to provide an oblique cap shoulder on the cap section and wherein the oblique cap shoulder faces the throat section.

10. The item hanging system as claimed in claim 9 wherein the auxiliary head is further comprised of a fillet between the oblique cap shoulder and the throat section.

11. The item hanging system as claimed in claim 10 wherein the cross-sectional area of the top end of the cap section is less than the cross-sectional area of the base of the skirt section.

12. The item hanging system as claimed in claim 10 wherein the shank of the nail is comprised of a smooth segment adjacent to the head end of the nail, wherein the shank of the nail is further comprised of a textured segment adjacent to the point end of the nail, and wherein the smooth segment is comprised of the embedded length of the shank of the nail.

13. The item hanging system as claimed in claim 10, further comprising a wire guide device for connecting with the wall hardware device in order to guide an item hardware wire into engagement with the auxiliary head.

14. The item hanging system as claimed in claim 13 wherein the wire guide device is comprised of a connecting segment for connecting with the wall hardware device and a guiding segment for guiding the item hardware wire into engagement with the auxiliary head.

15. The item hanging system as claimed in claim 14 wherein the connecting segment and the guiding segment are connected with each other so that the connecting segment defines a first plane, the guiding segment defines a second plane, and a connecting angle separates the first plane from the second plane, and wherein the wire guide device is configured so that when the wall hardware device is attached to a wall and the connecting segment is engaged with the wall hardware device, the guiding segment extends upward and away from the wall.

16. The item hanging system as claimed in claim 15 wherein the connecting segment is comprised of a connecting notch for engaging with the throat section of the wall hardware device.

17. The item hanging system as claimed in claim 16 wherein the connecting segment has a proximal end and a distal end, wherein the connecting notch is located between the proximal end and the distal end of the connecting segment, wherein the connecting segment is constructed of a resilient material, and wherein the connecting segment is further comprised of a concave connecting bow profile between the proximal end and the distal end of the connecting segment so that when the wall hardware device is attached to a wall and the connecting segment is engaged with the wall hardware device, the proximal end and the distal end of the connecting segment are urged into engagement with the wall.

18. The item hanging system as claimed in claim 16 wherein the guiding segment has a proximal end and a distal end, wherein the guiding segment is constructed of a resilient material, and wherein the guiding segment is comprised of a concave guiding bow profile between the proximal end and the distal end of the guiding segment.

19. The item hanging system as claimed in claim 17 wherein the guiding segment has a proximal end and a distal end, wherein the guiding segment is constructed of a resilient material, and wherein the guiding segment is comprised of a concave guiding bow profile between the proximal end and the distal end of the guiding segment.

20. The item hanging system as claimed in claim 19 wherein the wire guide device is constructed as a single piece of a resilient material.

21. The item hanging system as claimed in claim 19 wherein the wire guide device constructed as a single piece of a plastic.

22. A wire guide device for guiding an item hardware wire into engagement with a wall hardware device, the wire guide device comprising a connecting segment for connecting with the wall hardware device and a guiding segment for guiding the item hardware wire into engagement with the wall hardware device, wherein the connecting segment and the guiding segment are connected with each other so that the connecting segment defines a first plane, the guiding segment defines a second plane, and a connecting angle separates the first plane from the second plane, and wherein the wire guide device is configured so that when the wall hardware device is attached to a wall and the connecting segment is engaged with the wall hardware device, the guiding segment extends upward and away from the wall.

23. The wire guide device as claimed in claim 22 wherein the connecting segment is comprised of a connecting notch for engaging with the wall hardware device.

24. The wire guide device as claimed in claim 23 wherein the connecting segment has a proximal end and a distal end, wherein the connecting notch is located between the proximal end and the distal end of the connecting segment, wherein the connecting segment is constructed of a resilient material, and wherein the connecting segment is further comprised of a concave connecting bow profile between the proximal end and the distal end of the connecting segment so that when the wall hardware device is attached to a wall and the connecting segment is engaged with the wall hardware device, the proximal end and the distal end of the connecting segment are urged into engagement with the wall.

25. The wire guide device as claimed in claim 23 wherein the guiding segment has a proximal end and a distal end, wherein the guiding segment is constructed of a resilient material, and wherein the guiding segment is comprised of a concave guiding bow profile between the proximal end and the distal end of the guiding segment.

26. The wire guide device as claimed in claim 24 wherein the guiding segment has a proximal end and a distal end, wherein the guiding segment is constructed of a resilient material, and wherein the guiding segment is comprised of a concave guiding bow profile between the proximal end and the distal end of the guiding segment.

27. The wire guide device as claimed in claim 26 wherein the wire guide device is constructed as a single piece of a resilient material.

28. The wire guide device as claimed in claim 26 wherein the wire guide device is constructed as a single piece of a plastic.
